(19) United States
(12) Patent Application Publication
(10) Pub. No.: US 2020/0082390 A1
(43) Pub. Date: Mar. 12, 2020

(54) CRYPT-DECENTRALIZED CRYPTO-MONETIZATION SYSTEM AND METHOD

(71) Applicant: Nadir Mursalov, Makhachkala (RU)

(72) Inventor: Nadir Mursalov, Makhachkala (RU)

(73) Assignee: Sintez, LLC, Bloomfirld Hills, MI (US)

(21) Appl. No.: 16/128,461

(22) Filed: Sep. 11, 2018

(51) Int. Cl. G06Q 20/38; G06Q 20/06; G06F 16/182; H04L 9/06

(52) U.S. Cl. CPC G06Q 20/381; G06Q 20/065; H04L 2209/56; H04L 9/0643; H04L 2209/38; G06F 16/1824

(57) ABSTRACT

Software generates crypto currency due to the computing power of the user's computer. It contains a system for determining the characteristics of user's computer, control and accounting system (as well as computing of each user's profits), a system of automatic selection of the most efficient algorithm for mining. It differs from the all existing software systems for mining in that our software can work directly from the Internet browser and does not require installation on the user's computer.

### CROSS REFERENCE TO RELATED APPLICATIONS

This application claims priority to PCT application No. PCT/US18/19606 filed on Feb. 25, 2018 and incorporated herein by reference.

### FIELD OF THE INVENTION

This invention relates to digital currencies, and more particularly, to mining (generating) digital (crypto) currencies by the software platform/complex/system optimized to be integrated into social websites or social networks.

### BACKGROUND OF THE INVENTION

A major recent innovation in transaction and financial technology is the development of Crypto-Digital Financial Instruments (hereinafter referred to as crypto-currency or digital currency). Digital currencies serve as a digital medium of exchange in which the digital currencies may be transferred in exchange for goods and services. Crypto-currencies are examples of digital currencies in which cryptography governs the creation and exchange of value. These are currencies which are secured and verifiable utilizing various encryption schemes, primarily public/private encryption. Today, many of the systems dealing in crypto-currencies make use of recent software innovations, including decentralized, networked or public ledgers, and open source protocols. An example of the most famous of these protocols is “Bitcoin” (governed by the Bitcoin protocol), however, many other protocols exist. This is in contrast to traditional mediums of exchange that are governed, for example, by a central authority.

An open source protocol defines a system in which the creation and distribution of a certain crypto-currency, or plurality of crypto-currencies, is governed by consensus among a peer-to-peer network. The network maintains a public ledger in which new transactions are verified and recorded by members of the network via cryptography. The information for all crypto-currency transactions is embedded in what are called data blocks. Each of these blocks is interlinked with several others, creating a block chain. The operations of verifying and recording transactions of crypto-currencies, such as transactions in the bitcoin crypto-currency, are sometimes referred to as mining, because completion of each mining operation typically rewards the miner with newly created crypto-currency (e.g., bitcoins). In order for transactions to be verified, these blocks need to be analyzed/solved as quickly as possible. That is where the “miners” or “workers” come in. Miners are investors who devote computer space, energy/resources, and time to sort through data blocks. When their mining hits upon the right “hash”—a complex mathematical formula puzzle that helps not only verify transactions, but also create new currency—they submit their solution to the digital currency issuer. When their work and hash are verified, the miners receive a reward of a given number of digital coins. Verified transactions and newly created digital coins are recorded in the public ledger, known as the block chain. The public ledger serves as an official history of transactions. The amount of crypto-currency owned by any entity may be determined from the public ledger.

Crypto-currency mining operations involve compiling recent transactions into blocks and trying to solve a computationally difficult puzzle. The participant who first solves the puzzle gets to place the next block on the block chain and claim the rewards. The rewards, which incentivize mining, are both the transaction fees associated with the transactions compiled in the block as well as newly released crypto-currency.

In the earliest days of Bitcoin, mining was done with CPUs from normal desktop computers. Graphics cards, or graphics processing units (GPUs), became more effective at mining than CPUs and, as Bitcoin gained popularity, GPUs became dominant Eventually, hardware known as an ASIC, which stands for Application-Specific Integrated Circuit, was designed specifically for mining bitcoin. However, no system exists which would allow an interested user of a social network to begin mining digital currency in a very easy way directly from the Internet browser. Thus, there is a need for a system and/or method which integrates crypto-currency mining software into social networks and allows active peers of the network to generate crypto-currency directly in the Internet browser by a few clicks of their input device. Additionally, the disclosed system and method have the benefit of determining computing devices' configuration of the users, selecting the most optimal mining algorithm for the mining, and providing complete accounting of crypto-currency generation to the users. Thus, the system of the claimed invention provides an improvement in computer-related technology in terms of significantly simplifying the process of mining crypto-currency by being integrated into any social website and enabling users to mine digital currency via web browsers of the users.

### SUMMARY OF THE INVENTION

The following is a description of a decentralized crypto monetization system under the operating name CRYPT. It should be appreciated that the present embodiments can be implemented in numerous ways, such as a system, a method, or a computer program on a computer readable medium. Several embodiments are described below.

CRYPT is a software system optimized for integration into social networks in order to monetize the active audience of the network. Monetization, or mining, is carried out by utilizing the computational power (CPU and/or GPU) of personal computers of users in order to generate various crypto-currencies. Unlike any other mining systems, CRYPT is operated and controlled via a browser, using a personal web page of the users in a social network. The second key difference is the fact that the system is incredibly easy to use, requiring a minimum level of IT knowledge. The system is incredibly easy to use because no specialized installation or additional purchase is necessary. The only thing an interested user will have to do is to click ‘GENERATE MONEY’ button on the web page of the social network and the system will choose the optimal settings, and start the process of mining, giving the user their share, which can be precisely converted (if required) into a fiat currency of interest.

The system consists of the following five modules: Server Module, Web Module, Client Module, Pool Module and Wallet Module. The Server module is available for and controlled by the system's administrator. The Server module facilitates interaction with the Web Module embedded into the page of the social network, the Client Module installed on a personal computer of a user during the first launch of the system, the Mining Pool, and the Crypto Wallet. The Web Module provides control of the CRYPT system for the user. This module offers the visual interface that allows the user to start or stop CRYPT, as well as to open advanced settings of CRYPT. Another function of the Web Module is to display to the user of the system the current level of generated currencies, as well as overall generation speed, which is shown in the amount of crypto-currency that can be reached with the user's current settings and computer configuration per day, month, and year of continuous mining by CRYPT.

The Client Module is automatically installed during the first launch of the system which is registered as a service of the operating system and works in a hidden mode. The Client module communicates with the Server Module and the Web Module (via the Server Module), sends required information about the user's computing system to the Server, receives miners (i.e. the users who activated the system), starts and stops operation of the system by receiving the command, through the Server module, sent by the user via the Web Module. The Pool Module (also referred to as a ‘Mining Pool’) is a server that distributes the data blocks or tasks to be solved among all of the connected users. The Pool calculates the current level of generated currencies, as well as overall crypto-currency generation speed per day, month, and year of continuous mining by CRYPT. The Pool is used to control activities of all of the users (also referred to as ‘miners’) of the system, store information about the users' account information, statistics, and balance, and send the data to the Server module using its own API. The Crypto Wallet is the third server that has an administrative interface. It is used to store keys and currencies mined with the efforts of all of the users of the CRYPT system. This is the final storage for the crypto-currency, and the administrator of the platform can access it to withdraw the generated digital currency in order to exchange it, e.g. into fiat currencies. For the purpose of providing the highest level of safety and make the system secure, no other modules, except the Pool, is able to communicate with the Wallet. The Pool communicates with the Wallet in order to perform daily transactions pertaining to a plurality of crypto-currencies generated by users.

Miners of the Client Module are configured in such a way that the miner's crypto-currency generation activity has the lowest priority for the system. This enables the users to work, play games, or otherwise use their computing device without any interruptions, since the system will provide the required amount of resources for such tasks by configuring the mining activity to whatever computing resources are available with the other tasks running in the background.

A decentralized crypto-monetization system and method optimized for integration in social networks and utilized by at least one user of a social network to mine crypto-currency are disclosed comprising at least one computing device of one or more users; at least one graphical user interface (GUI) for displaying information to the one or more users; at least one input device for inputting data by the one or more users; a client module for communicating and interacting with the one or more computing devices of the one or more users; a web module for providing access to the system, via the GUI, for the one or more users through a social network page of the one or more users; a pool module for maintaining the one or more users of the system and controlling crypto-currency generation activities of the one or more users of the system; a wallet module for storing keys and crypto-currencies generated by the one or more users of the system, wherein the wallet module is communicatively coupled exclusively to the pool module; a server module for providing an administrator of the system administrative and operational control of the system, wherein the server module is configured to provide communication functionality between the client module, the web module, and the pool module via cryptography application programming interface (Crypto API), and wherein the server module is configured to communicatively couple the client module, the web module, and the pool module, whereby the client module, the web module, and the pool module are communicating with one another through the server module; at least one memory with non-transitory computer-readable program code stored thereon; and at least one processor operatively coupled to the memory, wherein the processor is configured to execute the computer-readable program code to receive commands of the one or more users of the system to install, start or stop the crypto-monetization system, wherein the commands are transmitted from the web module to the server module; receive commands of the one or more users of the system to adjust settings of the system, wherein the commands are transmitted from the web module to the server module; determine a configuration of the one or more users computing devices, wherein the configuration is determined by the client module and transmitted by the client module to the server module; select a mining algorithm according to the configuration of the one or more users computing devices and the system settings, wherein the mining algorithm is selected by the server module based on efficiency; generate crypto-currency by utilizing computing resources of the one or more users computing devices; convert funds of the generated crypto-currency into fiat currency of preference of the one or more users; generate account data associated with one or more crypto-currency accounts of the one or more users of the system, wherein the account data is generated by the pool module and transmitted to the server module; and display the account data to the one or more users of the system, wherein the account data is associated with the one or more users of the system, and wherein the account data is transmitted from the server module to the web module to be displayed to the one or more users associated with the account data.

The server module is further configured to prompt a response from the client module, wherein the response is that of a presence of response or an absence of response, wherein the presence of response indicates that a user is an active user of the system triggering the server module to send a command to the web module to display START and STOP buttons to the user via the GUI of the user, and the absence of response indicates that a user is not an active user of the system triggering the server module to send a command to the web module to display INSTALL button instead of START and STOP buttons; and receive a command from the user to start, stop, or install the system, wherein the command is input by the user via the web module, wherein, upon receipt of the command to install the system, the server module performs an installation of the client module on the computing device of the user.

The server module triggered to initiate the installation of the client module is further configured to receive a command from the user to install the client module; automatically add the user account data to one or more mining pools of the pool module; generate a personalized installation file of the client module for the user, wherein the personal installation file is unique for each user and is generated by the server module by receiving an encrypted social network identification of the user from the web module and assigning a new unique internal identifier for the user based on the social network identification of the user; receive an authorization to install from the user, and begin the installation of the client module.

The client module, in response to the user activating the INSTALL button, is configured to identify the new unique internal identifier of the user; communicate the internal identifier to the server module to validate the user as an identified user, wherein, in response that the user is not identified as being valid, the server module prompts the client module to re-check and re-send the internal identifier of the user to the server module, and, in response that the user is identified as a valid user, the client module is further configured to update a status of the client module as being ready to operate; and prompt the server module to provide the web module a command to replace the INSTALL button with the START and STOP buttons.

The server module, in response to the user activating the START button, is further configured to receive a command from the web module to begin a crypto-currency generation activity; transmit a command to the client module to collect the user computer configuration; receive the user computer configuration; receive the user settings from the web module; select a mining algorithm based on the user computer configuration and the settings; and begin a crypto-currency mining operation.

The server module, during the crypto-currency mining operation, is further configured to receive a notification data from the client module, wherein the notification data is based on the user mining activity; receive data from the pool module indicating the user speed with which the user accumulates crypto-currency based on the user computer configuration and the settings, receive data from the pool module indicating the user balance of the accumulated crypto-currency; and communicate the data to the web module, wherein an interface of the web module is configured to display the data to the user.

The client module, during the crypto-currency mining operation, is further configured to determine an activity status of the user based on data received from the user one or more input devices; and communicate the activity status of the user to the server module.

The server module has an option to instruct the client module to stop, replace or delete any user.

The system, in response to the user activating the START button, is further configured to send, by the server module, a mining software to the client module; launch, by the client module, the mining software on the computing device of the user; assign, by the pool module, data blocks to be solved by the mining software running on the computing device of the user; receive data blocks by the computing device of the user to be solved; send solved data blocks to the pool module for storage as block chains; generate crypto-currency for the solved data blocks; and send, by the pool module, the crypto-currency to the wallet module for a deposit into the user account.

The server module is further configured to receive, via the client module, the configuration of the user computing device; automatically select a mining algorithm for the mining operation of the user; receive, via the pool module, the user account data, wherein the account data comprises the user crypto-currency balance and balance in fiat currency of user preference; and display, via the web module, the crypto-currency account data including profits to the user.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

Further objects and advantages of the present invention will become apparent as the following description of the illustrative embodiments takes place, in which:

FIG. 1 is a system block diagram illustrating the overall integration of the crypto-currency-generation system into a social website/network according to one embodiment of the present invention.

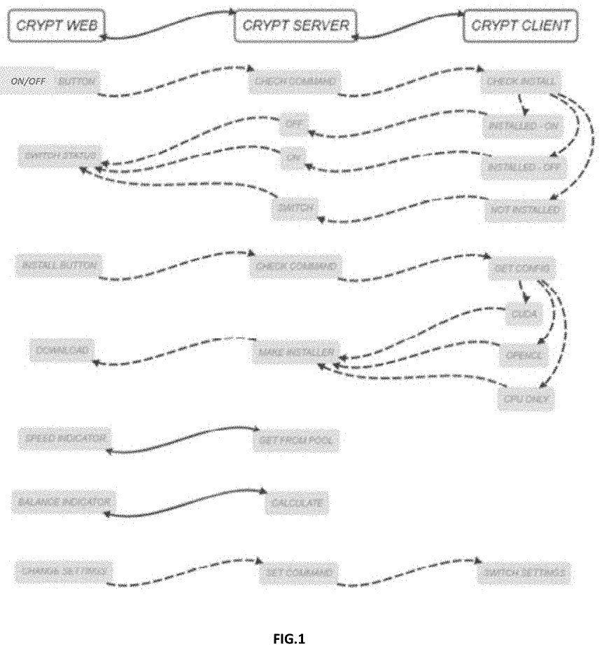

FIG. 2 is an illustrative diagram of the structural components that may mine digital currency in accordance with an embodiment of the present invention.

FIG. 3 is an illustrative diagram of a workflow of initiation of the crypto-currency web browser application in accordance with an embodiment of the present invention.

FIG. 4 is an illustrative diagram of initiation of an installation of the client module in accordance with an embodiment of the present invention.

FIG. 5 is an illustrative diagram of identification and verification of the user in accordance with an embodiment of the present invention.

FIG. 6 is an illustrative diagram of an activation of the crypto-currency mining operation in accordance with an embodiment of the present invention.

FIG. 7 is a flow chart of illustrative steps that may be performed by a processing core of crypto-currency mining circuitry to perform calculations of the speed and balance of the mining operation and reporting those results to the user.

### DETAILED DESCRIPTION OF THE INVENTION

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

This summary is not intended to identify key or essential features of the claimed subject matter, nor is it intended to be used in isolation to determine the scope of the claimed subject matter. The subject matter should be understood by reference to the entire specification of this patent, all drawings and each claim.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Accordingly, embodiments of the present invention may take the form of an entirely software embodiment (including firmware, resident software, micro-code, etc.), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, an electronic, magnetic, optical, electromagnetic, infrared, and/or semiconductor system, apparatus, and/or device. For example, in some embodiments, the computer-readable medium includes a tangible medium such as a portable computer diskette, a hard disk, a random-access memory (RAM), a read-only memory (ROM), an erasable programmable read-only memory (EPROM or Flash memory), a compact disc read-only memory (CD-ROM), and/or some other tangible optical and/or magnetic storage device.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general-purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a computer-readable medium (e.g., a memory) that can direct a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator- and/or human-implemented steps in order to carry out an embodiment of the present invention.

This invention includes an application supported by software that is adaptable to generate crypto-currency at the expense of the computing power/computing resources of the user's computer, i.e. crypto-currency monetization/mining/generation is achieved through the utilization of computing resources (processor and video card) of users' computing devices (PCs), in order to generate actual crypto-currency. The invention further includes a system for determining the characteristics/configuration of each user's computer, managing each user's accounting (i.e. computing/calculating each user's profits), automatically selecting for each user the most efficient algorithm for mining, and determining the speed and balance of the crypto-currency mining operation for each user. The subject of the present invention is patentable because it is distinct over all other prior art inventions of all existing software systems for mining in that the software of the present invention operates via a browser, using a personal web page of the users in a social network, and does not require an actual installation on a user's computer.

The term “module” denotes a functional operation that may be embodied either as a stand-alone component or as an integrated configuration of a plurality of subordinate components. A module is a software component or part of a program that contains one or more routines. One or more independently developed modules make up a program. An enterprise-level software application may contain several different modules, and each module serves unique and separate business operations. Thus, modules may be implemented as a single module or as a plurality of modules that operate in cooperation with one another. Moreover, modules may be implemented as software instructions stored in memory of the database of the server module. Furthermore, the modules of the present invention are a package management system which is a collection of software tools that automates the process of installing, upgrading, configuring, and removing computer programs for a computer's operating system in a consistent manner and is supported by a general-purpose computer programmable language such as Dart, Go or Java. The server module contains instructions for controlling processor to operate the system and execute the method described herein. Examples of the system and method are explained in further detail in the subsequent embodiments below.

The scope of the present invention supports all types of digital currencies in which cryptography governs the creation and exchange of value, wherein the program/application can work with all relevant crypto-currencies, including BitCoin (BTC), Litecoin (LTC), Ethereum (ETH), Zcash (ZEC), Dash, Ripple (XRP), Monero (XMR) and other currencies may be used without limiting the scope of the present invention. It also provides the possibility of mining using the means of the CPU for users with Nvidia and AMD video cards. The software determines whether the technical ability/capacity for mining is available on the user's hardware (PC) and what the characteristics are in order to select the most efficient algorithm for mining. The client module of the crypto-currency generation system of the present invention is fully compatibility with the Windows operating families, MAC OS X, as well as multiplatform. It should be noted, however, that the most ideal operating system(s) are Windows 7 and later versions due to the partial incompatibility of Windows XP with drivers for video cards with support of Cuda and Open CL. Nvidia cards with Cuda support, and AMD cards with OpenCL support should be engaged directly in crypto-generation. If there is no GPU in the user's system, then the mining is possible with the CPU. Supported operating systems includes the program works with the Windows family of operating systems, and later will be ported to OSX and Linux.

The supported browsers include all browsers of the Chromium family, as well as browsers based on the Gecko core. Later the program will get the function to work with a number of other popular browsers. Clear interface of the program includes the program that requires the least amount of action from the user. If the user does not have a library that is required for the mining process, the program will notify the user about it, and also offer to download it.

Components Interaction:

Four of the five modules of the system (Web, Server, Client, and Pool) interact with each other using CRYPT API. The Web Module sends the following commands to the Server Module: setting commands, information about the account of the user that initiates the module, as well as the start or stop commands. The Server Module makes attempt to connect to the Client Module, and if there's no response from the Client module, the Server understands that the Client and Web modules are not installed on the user's PC. In such a case, the Web module receives a command to replace the ‘START’ button with the ‘INSTALL’ button and display the ‘INSTALL’ button on the user's graphical user interface. Once a command to install the software is received from the user by the user clicking on the ‘INSTALL’ button, the Web module, embedded into the social web page of the user, transmits the user's social network identification (ID assigned to the user by the respective social network) to the Server module. The Server module stores the user's social network ID and assigns a new identification (unique internal ID) to the user, based on the user's social network ID. Each user is assigned a separate unique internal ID for each subcategory of the Mining Pool, the subcategories of the Mining Pool being responsible for mining particular crypto-currency. The Server module then sends a customized Client module installation file to the user. The customization is performed by including an encrypted authentication information to the user by using the information from the linked page that was used to launch the system. Thus, the Client module can be installed in just a couple of clicks. The Client module takes the role of an operating system which is completely hidden from the user's eyes. After the installation is complete, the Client module becomes connected to the Server module, and is used to send information to the Server module, using the embedded identifier, that the user is ready to mine digital currency. Having received the embedded identifier as an indication that the user is ready to mine, the Server Module sends a command to change the ‘INSTALL’ button with the ‘START’ button. Once the user clicks the ‘START’ button, the Web module, via a command, communicates to the Server module the user's desire to begin the mining operation by utilizing the system of the present invention. Once this indication is received by the Server module, the Server Module begins collecting, via a command to the Client module, the user's computer characteristics/configuration. The Client module, in turn, determines the user's computer characteristics/configuration and transmits the information to the Server module. Having collected this information, the Server module creates a customized miner profile. The foregoing process of software installation and creation of a customized miner profile is completely hidden from the eyes of the user. Having created a customized miner profile by the Server module, the Client module performs its hidden installation.

Once the user begins the mining operation, the Server module receives periodic notifications pertaining to the user's mining activity from the Client module during the entire process of mining by the user. Further, the Server module sends commands to the Mining Pool to determine speed with which the user accumulates digital currency under the user's settings and under the user's computer characteristics. Additionally, the Server module sends commands to the Mining Pool to determine the user's balance of the generated digital currency. Furthermore, the Server module is adapted to send commands to the Mining Pool to convert the generated digital currency, or any portion thereof, into fiat currency of the user's preference. Having received, by the Server module, the account/statistical data of the user's mining activity from the Mining Pool, the Server module transmits this information to the Web module which, in turn, displays this information to the user. As a default setting, which can be modified by the user or the system's administrator, the Mining Pool is configured to update the account/statistical data of the user's mining activity once a day. Similarly, by default, the generated digital currency is transferred to the crypto Wallet module once per day. These settings are also modifiable by the user or the system's administrator.

The system's browser part/Web module enables a user to gain access to the system through the user's personal social page. The basic elements as well as tasks/functional aspects of the web module are described herein in further detail.
(1) “INSTALL” or “START”/“STOP” buttons, wherein the dynamic buttons change visually and functionally depending on the Server commands “Start”: The Web module sends to the Server a command to start the process of mining using the user's computing system, subject to the user's settings. “Stop”: The Web module sends to the Server a request to stop the process of mining on the user's system subject to the user's settings. “Install”: The Web module sends a request to the Server pertaining to the Client module and receives the following answers [YES, active/Yes, passive/NO]. In the case of a negative answer, the Web module displays the button to “INSTALL” instead of the button to “START” or “STOP”. Clicking on the button by the user will send a request to the Server module to form a personalized installer within the Server with an internal user ID. The user will receive the created installer for downloading. After downloading and installing, the Client part will send a response to the Server part and the Server part will give a command to the Web module to replace the button “INSTALL” with the buttons “START”/“STOP”.
(2) “BALANCE” indicator shows the current balance of the user's funds in the system and becomes active only with a positive balance. Most of the data and processes are hidden from the user's view, in order to simplify interaction with the system. However, the balance is displayed to the user. It becomes available immediately after the Server sends a notification to the Web part that the Client module is ready for mining and there is any positive accumulation of funds in the user's account. The balance is not an indicator of an amount of digital currency generated by the system's means; rather, the Server module calculates, using the current conversion rates, and transmits to the browser the amount of funds, expressed in an official currency of the user's country of preference (fiat/official currency of the user's country of choice), the user has generated.
(3) “USER'S MINING PERFORMANCE” displays to the user the user's speed with which the user accumulates the funds, and the report is dynamically generated and displayed to the user indicating the user's performance “per day,” “per month,” and “per year”;
(4) “SETTINGS” is a small button that is displayed as a gear to the user. It opens access to the basic user settings and provides the user such options as “work only when idle”, “work half the power”, or “do not interrupt the operation when the browser is closed”. This section of the functions of the web module contains a number of user settings. Changing any of them leads to sending the appropriate command to the Server. To display the current settings, the Web module also accesses the Server module that stores this data. The first trigger in the settings, called “work only when idle”, will give the command to the Server that the Client module needs to be notified—it is necessary to stop the process of mining in cases where the user is interacting with the PC through input devices. The second trigger in the settings, called “half power work”, will give the command to the Server that it is necessary to slow down the mining operation and run only at half the performance of the video card or the user's processor. The third trigger in the settings, called “do not interrupt the operation when the browser is closed,” will give the Client module a command through the Server module that the mining process should not be stopped even if the Web module will stop responding to ping requests from the Server module. By default, the Client module gives frequent notifications to the Server that the mining starts and works, and a Web module gives to the Server module notification that an inset in a browser with the social page of user is open. As soon as the Server module stops receiving such notifications from the Web module, it will give a command to the Client module to stop the process of mining. The fourth trigger is called ‘utilize resources: GPU/CPU/GPU+CPU’. The last option is selected by default. This setting sends a command to the server in order to send information about utilized resources to the Client Module.

Additional features of the present invention, in accordance with the aspects of the current disclosure are provided herein:
(1) “SERVER API”—every interaction of the system's components, the social network, and the mining pool is carried out using internal API, as well as APIs of the social network and the mining pool.
(2) “CLIENT COMPATIBILITY” One of the key principles of the system is to provide full compatibility of the Client Module with the operating systems of Windows family. The Client Module can be easily ported to MAC OS X because the base of the Client Module supports different platforms. It's worth noting that the optimal working performance and the normal mining process are available on Windows 7 and higher because Windows XP doesn't provide full compatibility with drivers for GPU with Cuda and Open CL support.
(3) “WALLET” is a secure payment gateway that is used to withdraw money from the CRYPT Pool. The main function of the wallet is to store, exchange and ability to withdraw crypto-currency amounts generated by the user by the system's administrator. The users have no way to access the Wallet. Thus, the Wallet is a second (Server module being the first) internal component of the system, which is available for direct interaction only to administrators of the platform. In order to access the interface, one has to use a separate access panel, which has no direct connection with the Pool and the Server. It should be understood that the Server has no interaction with the Wallet. The Server's interaction with the Wallet is performed only through the Pool. In order to provide the highest security level, the wallet has no reverse connectivity feature. The most important task of the wallet is to be impenetrable. That's why a three-stage authentication system (LOGIN—PASSWORD—EMAIL CODE—SMS CODE) is the part of the wallet interface. The interface of the wallet is configured to show current amounts of cryptocurrencies, provide withdrawal features, as well as provide a conversion feature using specific gateways. Additionally, the interface of the wallet allows keeping track of the history of all the transactions.
(4) “MINING POOL” is a third internal component of the system. Thus, it is available for direct interaction only to the system's administrator. The pool interface can be accessed using the administrative interface of the Server Module. It is also known in the art that mining pools exist as a way for multiple devices to work together across the internet, pooling their resources in performing complex calculations to generate blocks of data. The mining ‘reward’ as it's known is then split proportionally amongst each participant. The method used to allocate rewards and the final amount a miner receives will depend on the mining pool in question. It should be understood that the system of the present invention is capable to connect/operate by utilizing, instead of the internal mining pool, various third-party mining pools, such as P2Pool, Slush Pool, AntPool, BTC.com, KanoPool, F2Pool, to name a few.
(5) “MERGED MINING” is the process of simultaneous mining of several different crypto-currencies. The system of the present invention is capable to facilitate hash solutions, which were not used in Bitcoin calculations, to calculate/generate other crypto-currencies simultaneously. The following currencies can be calculated in this mode: Namecoin, Devcoin, IxCoin, I0Coin, Litecoin, Dogecoin and etc. All of them have a high difficulty and a low exchange rate.

Client part installation of the present invention presupposes the following procedure: If the user wants to use the system for the first time, the system will provide the user an installation file personalized for his/her personal account. In order to maximize simplicity of interaction between the user and the system, the installation process will be automatic as long as the user starts it once. The installation procedure does not further inquire any other information from the user and, since the user identification (ID) was received from the user's personal page on the social network, the system inserts the user (ID) in the web browser of the social network page so that the user does not have to enter it manually into the client module. During the installation process, the Windows operating system will once ask for permission to make changes to the system. In the case of scaling, it is possible to obtain a digital certificate from the Microsoft, which releases the user from even making a click to confirm the installation. After the installation, the module will be attached to the user as a system service, place itself into the automatic download list, and visually will not be displayed anywhere, including the system tray and the taskbar. The client module does not have an interface as such, and all interaction with the user occurs through the connection of the client module to the server module, and then to the web module, and vice versa.

The tasks/functional aspects of the Client module are described herein in further detail.
(1) “Indication of an idle user”: At the request of the server module, the client module is tasked to determine whether the user's interaction with the system is idle by reading data from the user's input devices. If the user does not interact with the input devices for a pre-determined amount time, the client module gives a command to the server that the system is idle.
(2) “Indication of user's activity status”: The tasks of the client module include understanding whether the mining process is currently running, or whether it has been stopped. To accomplish this task, the client module pings the server module and transmits to the server module the following information: the “client module is installed and active” or “installed and passive”.
(3) “Indication of configuration/characteristics of user's PC”: An extremely important task of the client part is to determine the characteristics of the user's PC which is used by the server module to configure a certain miner and pick the most efficient algorithm for the user's subsequent mining operations. Once a miner is configured by the server module, the server will send the configuration to the client module.
(4) “Start/Stop mining operation”: The client module is responsible for loading the current miner from the server, with the user's internal ID settings, and starting, running the mining operation of the user in a hidden mode, as well as stopping the mining operation.
(5) “User replacement”: The client part is capable to make a hot-replacement of the user/miner, depending on the command from the server, i.e. stop the miner, delete the miner, get a new miner from the server.

The server part of the present invention operates as follows: The interaction of the components of the system between each other, a social network, and a pool, is carried out using the internal API, as well as the social network's API and the pool. The tasks/functional aspects of the server module are described herein in further detail:
(1) “User Account”: The server module is the coordination brain, mediator and the control center of the client and web modules which, generally, do not communicate directly with each other, i.e. all requests and responses pass through the server module. There is one exception: open source mining software (mining algorithm) is sent by the Server module to the Client module. The Client module, upon the user starting the mining operation, launches the mining software on the computing device of the user, and the Pool assigns over the Internet the data blocks to be solved/decrypted/processed by the mining software running on the user's computing device. The solved blocks by the users (i.e. by the mining software) are sent over the Internet directly to the Mining Pool without reaching the Server. The Pool stores the blocks as block chains and determines rewards (digital currency) for the user who successfully solved the data blocks (tasks). The rewards are later transferred to the Wallet module for depositing into a respective user account. The Server receives all the information pertaining to mining of the users directly from the Pool. Each user of the system receives an internal cell in the database which could be used by the user to perform various actions relating to the mining and accounting (locking, subtraction or addition of funds, force fixing a mining algorithm, viewing the history of the user's actions and the server's actions relative to it). The user's ID is assigned based on the user's ID in the social network as well as the user's number in the pool.
(2) “Calculation of the Optimal Algorithm”: The tasks of the server module include obtaining the user configuration (using the client module), preparing the miner from its configuration, and sending the ready-made miner to the client module. “Calculation” occurs according to the following non-limiting in scope, exemplary procedure: If the user has support of CUDA, the user is set up as a miner in the Zcash pool which works through the video card (GPU) with the user's internal ID number. If the user does not have such support of CUDA, but there is support of Open CL, the user is set up as a miner in the Etherium pool, and the corresponding miner generates digital currency through the video card (GPU), with the user's internal ID number. If the user does not have neither one nor the other, the user is set up as a miner in Monero pool, and the corresponding miner generates digital currency through the central processor (CPU) with the user's internal ID number. Monero pool that works off of CPU is created by default unless the user has chosen ‘Never utilize CPU resources’ tick in Web Module settings. However, the CPU miner is working simultaneously with the GPU, if available, by default. In case if the user has a 32-bit system instead of the 64-bit, the Server Module will provide the Client Module with the corresponding miners. The system's administrator is able to change the aforementioned logic, wherein the server communicates the command to the client module to either start or stop the current mining process, delete the miner, or update the miner.
(3) “Interaction with the mining pool”: The server works with the Mining Pool through its API. The purpose of the server's interaction with the mining pool is to convert a user into a miner in the mining pool as well as to parse the actual computing resources of the user.
(4) “Interaction with Exchange”: The server acts as a parser of the current exchange rate in order to be able to correctly recalculate user generated funds, according to the internal formula, into an official currency, and display this amount via the web module.
(5) “Interaction with the payment system”: The server module openly interacts with the user's internal purse in the social network, interacts at the API level with actions applicable to the funds accumulated by the user and calculates the balance of the user.
(6) “Assembling the installer of the client module”: As soon as the server module receives an indication that a user desires to use the system, the server module creates a personalized installer for the specific user, with an internal identifier of the user's account on a social network.

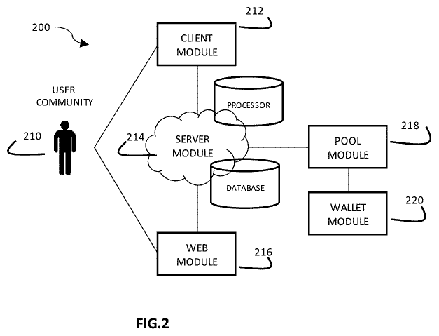

Referring now to FIG. 2 there is shown a block diagram (200) illustrating a decentralized crypto-currency mining system optimized for integration into social websites and/or networks. The system and method disclosed comprise a graphical user interface (210) of a user's computing device which receives input from the user; a client module (212) which communicates with the computing device of the user (210); a web module (216) which provides access for the web browser application of the present invention through the user's personal social network page; a server module (214) which provides storage database and operational control of the entire system; a pool module (218) for distributing data blocks to be solved to the users of the system, receiving data blocks that are solved, recording the solved blocks as block chains, and calculating rewards (digital currency) for the user who successfully solved at least one data block; a wallet module (220) for receiving and storing rewards from the pool module for at least one user of the system; and computer-readable instructions that are stored within the server module and are executed by the processor of the server to execute the steps and functions of the system. The logic, embedded in the computer-readable medium and supported by the computer-readable instructions, automatically selects the most efficient mining algorithm (software) based on the configuration of the user's computing device, enables the user to generate crypto-currency via computing resources/power of the user's computing device, converts funds of generated crypto-currency into fiat currency of preference of the user, and reports financial accounting including profits to the user.

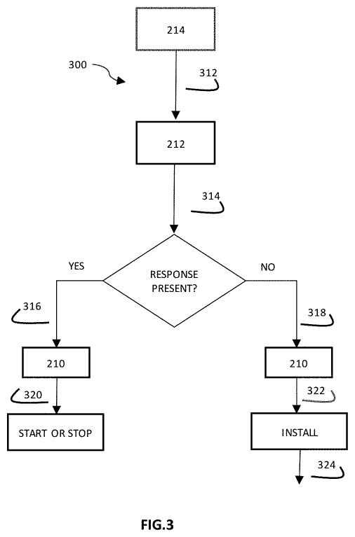

Referring now to FIG. 3, there is shown a flow chart diagram (300) representing the step-by-step operation of the server module (214). The server module (214) performs step (312) of connecting to the client module (212) in order to perform step (314) of prompting a response from the client module (212). In response to the prompt (314) by the server module (214), the client module (212) either responds or does not respond to the prompt (314). If the client module (212) responds, the process proceeds to the step (316) of sending a command to the client module (212) to proceed to step (320) of displaying on the GUI of the user (210) the “START”/“STOP” buttons. If, however, the client module (212) does not respond, the process proceeds to step (318) of sending a command to the client module (212) to proceed to step (322) of displaying on the GUI of the user (210) the “INSTALL” button.

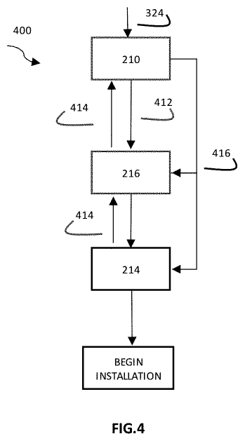

Referring now to FIG. 4, whenever the user (210) desires to mine crypto-currency by using the system of the present invention for the first time, i.e. by clicking the button “INSTALL” (324) on the GUI of the user (210), the process proceeds to step (412) of transmitting the installation trigger to the web module (216) and then to step (414) of initiating the server (214). The server module (214), which is triggered to initiate the installation of the client module (212), automatically adds the user account data to a mining pool and provides the user with a personalized installation file of the client module in step (414), wherein the personal installation file is generated by the server module by adding encrypted user authorization information or internal user identification, based on data from a web browser page of the user, and, upon receipt of authorization from the user in step (416), begins the installation of the client module.

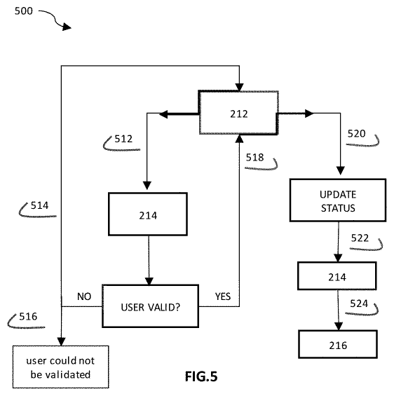

Referring now to FIG. 5, the client module (212), after being installed, identifies the user by an internal identifier and communicates the internal identifier in step (512) to the server module (214) to validate the user as an identified user. If the user is validated by the server module (214), the successful validation is communicated in step (518) to the client module (212) which, in turn, updates its status in step (520) as “being ready to operate” and prompts in step (522) the server module (214) to provide in step (524) the web module (216) a command to replace the “INSTALL” button with the “START”/“STOP” buttons, thereby completing the process. If, however, the user is not identified as a valid user, the process proceeds to step (514) of prompting the client module (212) to re-check (identify the user by the internal identifier one more time), and communicate (512) the internal identifier to the server module (214) for validation. If the validation procedure was unsuccessful after the second attempt, the process moves through step (516) to display the message “user could not be validated” to the user (210), thereby completing the process.

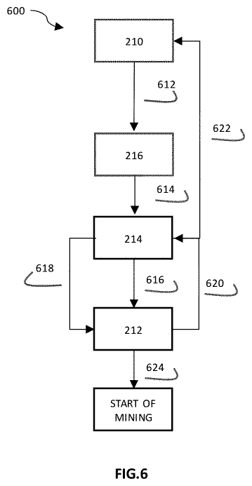

Referring now to FIG. 6, after the user (210) activates the “START” button, the process proceeds to step (612) which prompts the web module (216) to send a command (614) to the server module (214) to request (616) an identification of the user's computing device from the client module (212). Upon receipt of the identification in step (620), the server module (214) automatically generates an encapsulated and customized miner identification (ID) for the user and provides the client module (212) with the miner ID in step (622), and prompts an automatic and anonymous start (624) of a crypto-currency mining operation.

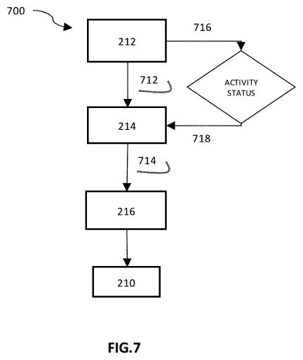

Referring now to FIG. 7, the server module (214), during the crypto-currency mining operation, in step (712) receives a notification data from the client module (212), wherein the notification data is based on a data of the mining pool (218). The server module (214) receives, based on the data calculated by the mining pool, speed and balance of the mining operation of the user, and communicates in step (714) the speed and balance data to the web module (216), wherein an interface of the web module is configured to display the data to the user (210). The client module, meanwhile, determines a status level of the user's mining activity in step (716), based on a data received from the user's input devices, and communicates in step (718) the status level of the user's activity to the server module (214).

The steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such the processor can read information from, and write information to, the storage medium. In the alternative, the storage medium can be integral to the processor. The processor and the storage medium can reside in an ASIC.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention. References to a “page” refer to a visual display of information such as a web page or other representation of information presented to a user on a computer display device.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A decentralized crypto-monetization system optimized for integration in social networks and utilized by at least one user of a social network to mine crypto-currency, the decentralized crypto-monetization system comprising:
at least one computing device of one or more users;
at least one graphical user interface (GUI) for displaying information to the one or more users;
at least one input device for inputting data by the one or more users;
a client module for communicating and interacting with the one or more computing devices of the one or more users;
a web module for providing access to the system, via the GUI, for the one or more users through a social network page of the one or more users;
a pool module for maintaining the one or more users of the system and controlling crypto-currency generation activities of the one or more users of the system;
a wallet module for storing keys and crypto-currencies generated by the one or more users of the system, wherein the wallet module is communicatively coupled exclusively to the pool module;
a server module for providing an administrator of the system administrative and operational control of the system, wherein the server module is configured to provide communication functionality between the client module, the web module, and the pool module via cryptography application programming interface (Crypto API), and wherein the server module is configured to communicatively couple the client module, the web module, and the pool module, whereby the client module, the web module, and the pool module are communicating with one another through the server module;
at least one memory with non-transitory computer-readable program code stored thereon; and
at least one processor operatively coupled to the memory, wherein the processor is configured to execute the computer-readable program code to:
receive commands of the one or more users of the system to install, start or stop the crypto-monetization system, wherein the commands are transmitted from the web module to the server module;
receive commands of the one or more users of the system to adjust settings of the system, wherein the commands are transmitted from the web module to the server module;
determine a configuration of the one or more users computing devices, wherein the configuration is determined by the client module and transmitted by the client module to the server module;
select a mining algorithm according to the configuration of the one or more users computing devices and the system settings, wherein the mining algorithm is selected by the server module based on efficiency;
generate crypto-currency by utilizing computing resources of the one or more users computing devices;
convert funds of the generated crypto-currency into fiat currency of preference of the one or more users;
generate account data associated with one or more crypto-currency accounts of the one or more users of the system, wherein the account data is generated by the pool module and transmitted to the server module; and
display the account data to the one or more users of the system, wherein the account data is associated with the one or more users of the system, and wherein the account data is transmitted from the server module to the web module to be displayed to the one or more users associated with the account data.

2. The decentralized crypto-monetization system of claim 1, wherein the server module is further configured to:
prompt a response from the client module, wherein the response is that of a presence of response or an absence of response, wherein the presence of response indicates that a user is an active user of the system triggering the server module to send a command to the web module to display START and STOP buttons to the user via the GUI of the user, and the absence of response indicates that a user is not an active user of the system triggering the server module to send a command to the web module to display INSTALL button instead of START and STOP buttons; and
receive a command from the user to start, stop, or install the system, wherein the command is input by the user via the web module, wherein, upon receipt of the command to install the system, the server module performs an installation of the client module on the computing device of the user.

3. The decentralized crypto-monetization system of claim 2, wherein the server module triggered to initiate the installation of the client module is further configured to:
receive a command from the user to install the client module;
automatically add the user account data to one or more mining pools of the pool module;
generate a personalized installation file of the client module for the user, wherein the personal installation file is unique for each user and is generated by the server module by receiving an encrypted social network identification of the user from the web module and assigning a new unique internal identifier for the user based on the social network identification of the user;
receive an authorization to install from the user, and
begin the installation of the client module.

4. The decentralized crypto-monetization system of claim 3, wherein, in response to the user activating the INSTALL button, the client module is configured to:
identify the new unique internal identifier of the user;
communicate the internal identifier to the server module to validate the user as an identified user, wherein, in response that the user is not identified as being valid, the server module prompts the client module to re-check and re-send the internal identifier of the user to the server module, and, in response that the user is identified as a valid user, the client module is further configured to:
update a status of the client module as being ready to operate; and
prompt the server module to provide the web module a command to replace the INSTALL button with the START and STOP buttons.

5. The decentralized crypto-monetization system of claim 4, wherein, in response to the user activating the START button, the server module is further configured to:
receive a command from the web module to begin a crypto-currency generation activity;
transmit a command to the client module to collect the user computer configuration;
receive the user computer configuration;
receive the user settings from the web module;
select a mining algorithm based on the user computer configuration and the settings; and
begin a crypto-currency mining operation.

6. The decentralized crypto-monetization system of claim 5, wherein the server module, during the crypto-currency mining operation, is further configured to:
receive a notification data from the client module, wherein the notification data is based on the user mining activity;
receive data from the pool module indicating the user speed with which the user accumulates crypto-currency based on the user computer configuration and the settings,
receive data from the pool module indicating the user balance of the accumulated crypto-currency; and
communicate the data to the web module, wherein an interface of the web module is configured to display the data to the user.

7. The decentralized crypto-monetization system of claim 6, wherein the client module, during the crypto-currency mining operation, is further configured to:
determine an activity status of the user based on data received from the user one or more input devices; and
communicate the activity status of the user to the server module.

8. The decentralized crypto-monetization system of claim 1, wherein the server module is operative to instruct the client module to stop, replace or delete the user.

9. The decentralized crypto-monetization system of claim 5, wherein, in response to the user activating the START button, the system is further configured to:
send, by the server module, a mining software to the client module;
launch, by the client module, the mining software on the computing device of the user;
assign, by the pool module, data blocks to be solved by the mining software running on the computing device of the user;
receive data blocks by the computing device of the user to be solved;
send solved data blocks to the pool module for storage as block chains;
generate crypto-currency for the solved data blocks; and
send, by the pool module, the crypto-currency to the wallet module for a deposit into the user account.

10. The decentralized crypto-monetization system of claim 1, wherein the server module is further configured to:
receive, via the client module, the configuration of the user computing device;
automatically select a mining algorithm for the mining operation of the user;
receive, via the pool module, the user account data, wherein the account data comprises the user crypto-currency balance and balance in fiat currency of user preference; and
display, via the web module, the crypto-currency account data including profits to the user.

11. A method of integration of a decentralized crypto-monetization platform in social networks to enable at least one user of a social network to mine crypto-currency, the method comprising:
receiving commands of at least one user to install, start or stop the decentralized crypto-monetization platform, wherein the commands are transmitted from a web module to a server module;
receiving commands of the at least one user to adjust settings, wherein the commands are transmitted from the web module to the server module;
determining a configuration of the at least one user computing devices, wherein the configuration is determined by a client module and transmitted by the client module to the server module;
selecting a mining algorithm according to the configuration and the settings, wherein the mining algorithm is selected by the server module based on efficiency;
generating crypto-currency by utilizing computing resources of the at least one user computing device;
converting funds of the generated crypto-currency into fiat currency of preference of the at least one user;
generating account data for the at least one user, wherein the account data is generated by a pool module and transmitted to the server module; and
displaying the account data to the at least one user, wherein the account data is associated with the at least one user, and wherein the account data is transmitted from the server module to the web module to be displayed to the at least one user associated with the account data.

12. The method of claim 11, wherein the method further comprises:
prompting by the server module a response from the client module, wherein a presence of response indicates that a user is an active user triggering the server module to send a command to the web module to display START and STOP buttons to the user via a GUI of the user, and an absence of response indicates that a user is not an active user triggering the server module to send a command to the web module to display INSTALL button instead of START and STOP buttons; and
receiving by the server module a command from the user to start, stop, or install the platform, wherein the command is input by the user via the web module, wherein, upon receipt of the command to install the system, the server module performs an installation of the client module on the computing device of the user.

13. The method of claim 12, wherein the method further comprises:
receiving by the server module a trigger to initiate the installation of the client module;
receiving by the server module a command from the user to install the client module;
automatically adding by the server module the user account data to one or more mining pools of the pool module;
generating by the server module a personalized installation file of the client module for the user, wherein the personal installation file is unique for each user and is generated by the server module by receiving an encrypted social network identification of the user from the web module and assigning a new unique internal identifier for the user based on the social network identification of the user;
receiving by the server module an authorization to install from the user, and
beginning by the server module the installation of the client module.

14. The method of claim 13, wherein, in response to the user activating the INSTALL button, the method further comprises:
identifying by the client module the new unique internal identifier of the user;
communicating by the client module the internal identifier to the server module to validate the user as an identified user, wherein, in response that the user is not identified as being valid, the server module prompts the client module to re-check and re-send the internal identifier of the user to the server module, and, in response that the user is identified as a valid user, the client module is further configured to:
updating a status of the client module as being ready to operate; and
prompting the server module to provide the web module a command to replace the INSTALL button with the START and STOP buttons.

15. The method of claim 14, wherein, in response to the user activating the START button, the method further comprises:
receiving by the server module a command from the web module to begin a crypto-currency generation activity;
transmitting by the server module a command to the client module to collect the user computer configuration;
receiving by the server module the user computer configuration;
receiving by the server module the user settings from the web module;
selecting by the server module a mining algorithm based on the user computer configuration and the settings; and
beginning by the server module a crypto-currency mining operation.

16. The method of claim 15, the method further comprises:
receiving by the server module a notification data from the client module, wherein the notification data is based on the user mining activity;
receiving by the server module data from the pool module indicating the user speed with which the user accumulates crypto-currency based on the user computer configuration and the settings,
receiving by the server module data from the pool module indicating the user balance of the accumulated crypto-currency; and
communicating by the server module the data to the web module, wherein an interface of the web module is configured to display the data to the user.

17. The method of claim 16, the method further comprises:
determining by the client module an activity status of the user based on data received from the user one or more input devices; and
communicating by the client module the activity status of the user to the server module.

18. The method of claim 11, the method further comprises:
receiving by the client module instructions from the server module to stop, replace or delete the user.

19. The method of claim 15, the method further comprises:
in response to the user activating the START button, sending by the server module a mining software to the client module;
launching by the client module the mining software on the computing device of the user;
assigning by the pool module data blocks to be solved by the mining software running on the computing device of the user;
receiving data blocks by the computing device of the user to be solved;
sending solved data blocks to the pool module for storage as block chains;
generating crypto-currency for the solved data blocks; and
sending by the pool module the crypto-currency to the wallet module for a deposit into the user account.

20. The method of claim 15, the method further comprises:
receiving by the server module the configuration of the user computing device, wherein the configuration is collected and transmitted by the client module;
automatically selecting by the server module a mining algorithm for the mining operation of the user;
receiving by the server module the user account data, wherein the account data and collected and transmitted by the pool module, wherein the account data comprises the user crypto-currency balance and balance in fiat currency of user preference; and
displaying, via the web module, the crypto-currency account data including profits to the user.
